(19) United States
(12) Patent Application Publication
(10) Pub. No.: US 2011/0056240 A1
(43) Pub. Date: Mar. 10, 2011

(54) FREEZE PLUG SYSTEM AND METHOD OF OPERATION

(75) Inventors: Paul Malik, Northport, NY (US); Joseph Carbonara, Manalapan, NJ (US); John T. Gaughan, Carmel, NY (US); Hans K. Malik, Ellicott City, MD (US)

(73) Assignee: CONSOLIDATED EDISON COMPANY OF NEW YORK, INC., New York, NY (US)

(21) Appl. No.: 12/555,488

(22) Filed: Sep. 8, 2009

(51) Int. Cl. F25J 1/00; F16L 53/00; H05B 1/02

(52) U.S. Cl. 62/657; 392/468; 219/494; 137/468

(57) ABSTRACT

A freeze and thaw system using knowledge-based hardware and methodology is provided for repair of oil-filled pipes. Liquid nitrogen is boiled off inside freeze jackets installed over the pipe, exiting in a superheated vapor state. Liquid nitrogen flow rates, controlled by the temperature controllers, are based on the requirements of the freeze process to maintain a desired level of superheat. The freeze operation is divided into distinct phases each with a different nitrogen superheated exhaust temperature. At the end of the repair, electric heaters wrapped over the pipe proceed to thaw the frozen oil. The heater controller thaws the frozen plugs based on an embedded time versus temperature protocol. The freeze prevention heaters are wrapped over the freeze jackets to prevent ice formation over the cold freeze jackets while the freeze plug is formed and maintained. This technology results in less thaw and freeze time at reduced liquid nitrogen usage.

### BACKGROUND OF THE INVENTION

The present invention relates generally to a system for freezing and thawing stationary oil in a section of a pipe to create a frozen plug. As these underground pipes do not incorporate any isolation valves, the plugs serve that function. This allows repair in the oil-filled pipes that also contain high voltage electric cables. At the end of the repairs, the frozen plug is thawed to initiate oil flow through the pipe.

Fluid filled pipes are used in a variety of applications such as equipment used in food processing systems, water delivery systems, cooling of High Voltage electric cables, electrical distribution systems as well as the exploration, delivery and processing of oil, natural gas and their end products. The fluid may be in the pipes for a variety of purposes, such as delivery of the fluid to an end point, to transfer or deliver thermal energy to a system, or to isolate a component within the pipe from the external environment.

One exemplary application is a system having long distances of uninterrupted dielectric oil filled pipe containing electric cables to transmit high voltage electric power. These systems are used to transfer electrical power from electrical production facilities to areas where the electrical power will be consumed. In some areas, many miles may separate electrical production and consumption areas. It is not uncommon for transmission cables to extend over 8 miles (13 km) to 15 miles (24 km). Several different types of conductors or cables are used in the transmission of high voltage electricity. For underground cables, the conductors are housed inside a steel pipe containing dielectric fluid. The pipe is typically carbon steel having a quarter-inch (0.64 cm) wall. The pipe protects the power cables and acts as a vessel for containing the dielectric fluid. One issue that arises in underground installations is the heat and electrical fields generated by the high voltage cables. The high-pressure dielectric fluid surrounding the cables provides both cooling and electrical insulating functions.

During normal use over an extended period of time, leaks of dielectric fluid through the steel pipe can sometimes occur. These leaks may be due to a number of reasons, such as shooting fluid jet from an adjacent water or steam pipe, mechanical fatigue, or corrosion for example. It should be appreciated that the leakage of the dielectric fluid may be undesirable environmentally and result in degradation in the performance of the cable. Since there are few or no valves installed in transmission cables, one method of repair involves freezing the dielectric fluid on either side of the area needing repair. The freezing creates a highly viscous plug of frozen dielectric fluid that allows the repair area to be isolated for draining and maintenance functions.

Since dielectric fluid has a low freezing point, a cooling liquid, such as liquid nitrogen for example, is used to form the freeze plugs. Typically, the liquid nitrogen is introduced into the freeze jackets that are installed to encircle the pipe. While the method is effective, it does have several drawbacks. There is poor contact between the freeze jackets and the outside wall of the pipe. Since the heat transfer mechanism is by conduction, poor contact between the jackets and the pipe does not help the heat transfer. Thus large amounts of liquid nitrogen are required over an extended period of time. Typically, it takes 10 to 12 hours for a proper freeze plug to form. Also, since these transmission cables may be located in a metropolitan area, any delays in the delivery of adequate quantities of liquid nitrogen may cause issues in forming and maintaining the freeze plugs.

This process of forming the freeze plug also results in a large block of ice forming around the outside surfaces of the freeze jackets. While the block of ice may assist in holding the cable and freeze plug temperatures, it also lengthens the time it takes to thaw the freeze plug. Typically, using this method, it takes 8 to 24 hours to thaw the oil around the transmission cables once the repairs have been completed. To facilitate the thawing, it is common to use propane or kerosene heaters that blow hot air across the accumulated ice. It should be appreciated that since the transfer of electrical power is terminated once the repairs are initiated, and it cannot be restored until the oil around the transmission cables has been thawed, therefore it is desirable to minimize the amount of time needed to form and thaw the freeze plugs.

It should also be appreciated that it would be desirable to reduce the freeze and thaw time periods in other applications as well. For example, in a food processing facility, production could be halted during the repair, or in a water distribution system, water would not be delivered to end customers during the repair.

While existing systems and methods for thawing pipes are suitable for their intended purposes, there still remains a need for improvements, particularly regarding the amount of time needed to thaw the fluid filled pipes.

### SUMMARY OF THE INVENTION

In accordance with one embodiment of the invention, a device for warming a frozen pipe is provided. The device includes a first heater disposed about the frozen pipe, the first heater having a heating element. An insulation layer is disposed about the first heater. A second heater is disposed about the heater. A temperature sensor is arranged in thermal contact with the heating element.

In accordance with another embodiment of the invention, a device for generating a freeze plug is provided. The device includes a jacket and a first tube fluidly coupled to the jacket adjacent a first end. A second tube is fluidly coupled to the jacket adjacent a second end, wherein the second end is opposite the first end. A first valve is coupled to the first tube. A first temperature sensor is thermally coupled to the second tube. A controller is electrically coupled to the first temperature sensor and the first valve, the controller includes a processor that is responsive to executable computer instructions for modulating the first valve in response to a signal from the first temperature sensor such that a superheated level of a gas flowing from the jacket through the second tube is maintained.

In accordance with another embodiment of the invention, a method of operating a device for warming a frozen pipe is provided. The method includes the step of operating a first heater, wherein the first heater has a heater element and is disposed about the frozen pipe. A first temperature of the heater element is monitored. The first heater is disabled when the first temperature exceeds a first threshold. A second heater is operated at a substantially constant second temperature, wherein the second heater is disposed about the first heater.

In accordance with another embodiment of the invention, a method of operating a device for forming a freeze plug in a pipe is provided. The method includes the steps of flowing a cryogenic liquid into a first chamber, wherein the first chamber is in thermal contact with the pipe. The cryogenic liquid is boiled in the first chamber to form a cryogenic superheated gas. A first temperature of the cryogenic gas exiting the first chamber is monitored. A first valve is modulated to adjust the flow of the cryogenic liquid in response to the first temperature. The first temperature of the cryogenic gas is maintained at a desired level of superheat by modulating the first valve. A first heater is operated at a substantially constant second temperature and a freeze plug is formed in the pipe.

### BRIEF DESCRIPTION OF THE DRAWINGS

Referring now to the drawings, which are meant to be exemplary and not limiting, and wherein like elements are numbered alike:

FIG. 1 is an illustration of a prior art high voltage conductor arrangement;

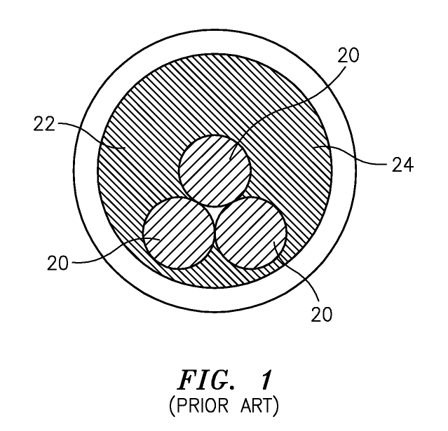

FIG. 2 is a perspective view illustration of a device for forming and thawing a freeze plug in a pipe in accordance with an exemplary embodiment of the invention;

FIG. 3 is a sectional view illustration of the device of FIG. 2 installed on high voltage conductor of FIG. 1;

FIG. 4 is a side plan view illustration of the device of FIG. 2;

FIG. 5 is a schematic illustration of a controller for the device of FIG. 2;

FIG. 6 is a schematic illustration of a temperature sensor arrangement for the device of FIG. 2;

FIG. 7 is a block diagram illustration of an exemplary method of operating the device of FIG. 2;

FIG. 8 is a temperature profile illustration for the exhaust temperature for the device of FIG. 2;

FIG. 9 is a block diagram illustration of another embodiment method of operating the device of FIG. 2;

FIG. 10 is a block diagram illustration of another embodiment method of operating the device of FIG. 2;

FIG. 11 is a block diagram illustration of an embodiment for thawing a frozen pipe; and,

FIG. 12 is a temperature profile illustration for the thaw heater temperature setting for the device of FIG. 2.

### DETAILED DESCRIPTION

Fluid filled pipes are used in a wide variety of applications. In some applications the pipes do not include valves that allow the conduit to be segmented for maintenance or repair. Valves may not be included for a number of reasons. For example in the transmission of high voltage electrical power, the electrical power conductors 20 are housed within a pipe 22 that contains a dielectric fluid 24. The dielectric fluid 24 isolates the power conductors 20 and also helps heat transfer that is generated by the power conductors 20 during operation. Since a valve would interfere with the power conductors 20, fluid filled high voltage transmission lines operate contiguously over long distances with no mechanism for segmenting the sections of pipe.

It should be appreciated that high voltage transmission lines may operate contiguously for many miles. To drain the entire line would be a lengthy and costly procedure. Further, service to customers along the entire length of the transmission line would be interrupted. Therefore, in the event the high voltage transmission line needs repair, maintenance or upgrading, the pipe 22 needs to be segmented to minimize the amount of dielectric fluid 24 that needs to be drained. While the embodiments herein discuss the application of a device for forming, maintaining and thawing a freeze plug with respect to high voltage transmission lines, this is for exemplary purposes and not intended to be limiting. It should be appreciated that the device discussed herein may be used in any application requiring a removable plug in a fluid filled pipe or conduit.

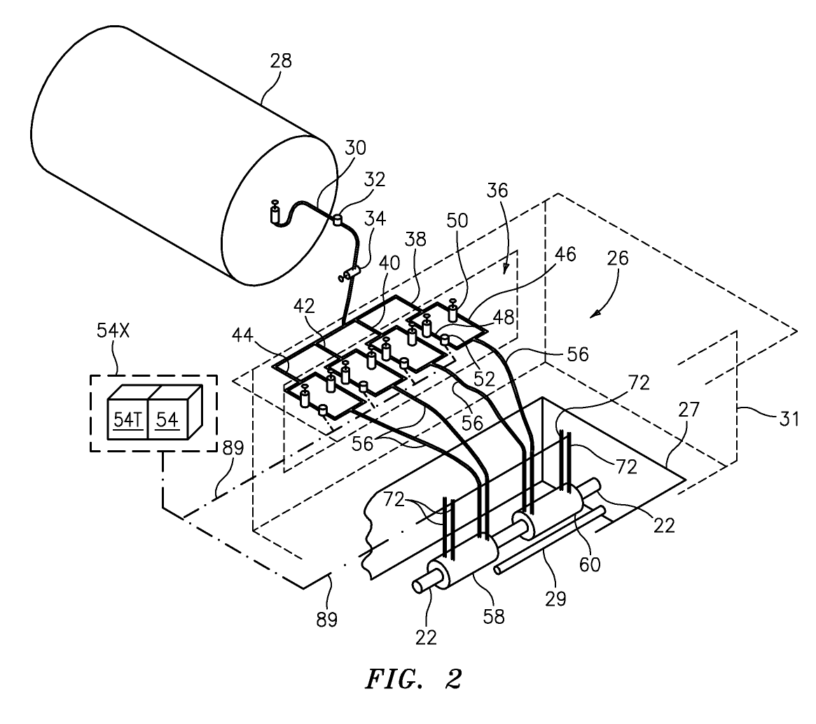

Referring now to FIGS. 2-6, an exemplary device 26 for forming a plug in a fluid filled pipe will be described. In general, the device 26 consists of systems for freezing, thawing, providing a cryogenic supply, display/logger and various controllers, such as the freeze and thaw controller 54X for example. In the case of high voltage electrical lines, the pipe 22 will be located below grade, such as under a street for example. The pipe 22 is accessed in a chamber or pit 27 is formed around the pipe 22. It should be appreciated that other pipes 29 or utilities, such as electrical power lines, telecommunications line or water lines may also be located in the pit 27. It should be appreciated that the operation of the freeze/thaw device 26 should not interfere with the operations of the other utilities. As will be made clearer herein, one of the advantages of the device 26 is the flexibility it provides in operating in these types of environments. Since repairs may be performed over an extended period of time, in most embodiments, a temporary shelter 31 is constructed over the pit 27 to protect the device 26 from the environment.

The device 26 receives a cooling fluid from a source 28. The source 28 may be a tank trailer for example. In the exemplary embodiment, the cooling fluid is a cryogenic fluid, such as liquid nitrogen for example. The cooling fluid leaves the source 28 through a tube 30. The tube 30 may include a number of components to regulate the flow of the cooling fluid, such as a pressure regulator 32 and relief valve 34 for example.

The tube 30 terminates at a manifold 36. In the exemplary embodiment, the manifold 36 includes four segments 38, 40, 42, 44. In the exemplary embodiment, the four segments 38, 40, 42, 44 are substantially identical. As will be discussed in more detail below, the segments 38, 40, 42, 44 deliver the cooling fluid to a portion of a freeze jacket that is coupled to the pipe 22. Each segment bifurcates into a pair of tubes 46, 48. The first tube 46 includes a bypass valve 50. The second tube 48 includes a solenoid valve 52. As will be discussed in more detail below, each of the solenoid valves 52 is electrically coupled to a freeze controller 54. In the exemplary embodiment, the bypass valve 50 is a manually operated normally closed valve that allows the flow of cooling fluid through to the jacket in the event that the solenoid valve 52 does not operate properly.

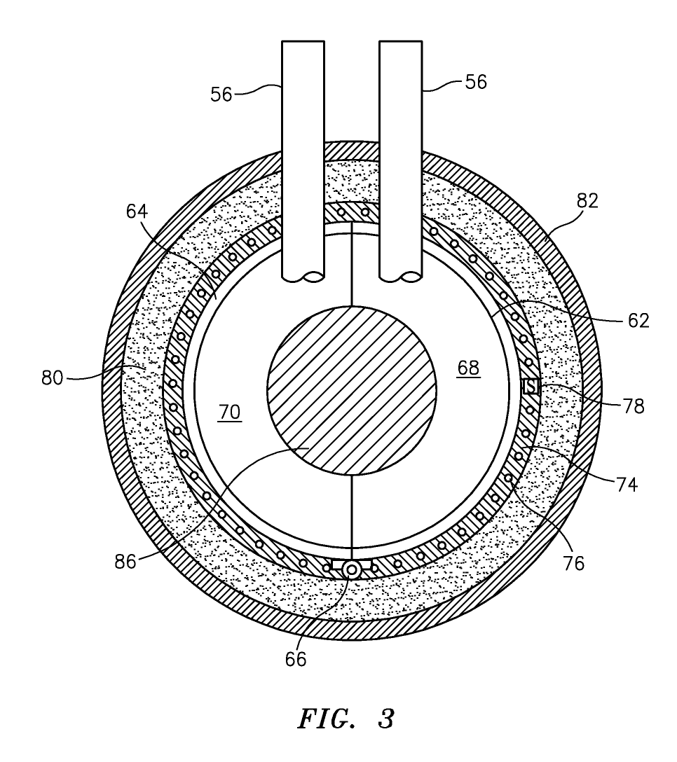

The pair of tubes 46, 48 connect back together and couple to a tube 56 that connects the pair of tubes 46, 48 to the freeze jackets 58, 60. In the exemplary embodiment, the freeze jackets 58, 60 each include a first half 62 and a second half 64 as illustrated in FIG. 3. A hinge 66 rotatably couples the first half 62 and second half 64 to each other. The hinge 66 allows the freeze jackets 58, 60 to be easily installed and removed from the fluid filled power conductor pipe 22 without disturbing the pipe 22. In one embodiment, one or more temperature sensors 61 are positioned between the inner diameter of the freeze jackets 58, 60 and the pipe 22. Further, it should be appreciated that the freeze jackets 58, 60 may also be arranged in another form or shape that allows the cooling fluid to be introduced to substantially the entire circumference of the pipe 22, such as in four segments for example, without deviating from the intended scope of the claimed invention.

Each of the tubes 56 are fluidly coupled to one of the halves 62, 64 to allow the cooling fluid to flow into a chamber 68, 70 shown in FIG. 3. The chambers 68, 70 extend substantially along the length of the jackets 58, 60. An exhaust tube 72 is coupled to the end of each chamber 68, 70. In the exemplary embodiment, the jackets 58, 60 are made from a suitable material, such as steel, copper or aluminum, that has high thermal conductivity properties and is able to withstand thermal cycling between ambient and cryogenic temperatures.

Disposed about the jackets 58, 60 are thaw heaters 74 as shown in FIG. 3. In the exemplary embodiment, the thaw heater 74 is a resistance heater capable of operating over a cryogenic temperature range of −200° C. (the temperature of liquid nitrogen in the jackets 58, 60) to 100° C. (maximum heater surface temperature). The thaw heater 74 includes an element 76 that generates thermal energy in response to the application of an electrical current flowing through the element 76. In the exemplary embodiment, the thaw heater 74 has a power rating of 1.1 kW to 1.8 kW and has a surface area of 8.75 ft² for a 10-inch (0.254 meters) diameter pipe 22. The thaw heater 74 may also include a temperature sensor or a thermal cutout switch 78 arranged to monitor the temperature of the element 76. As will be discussed in more detail below, the cutout switch 78 is coupled to the thaw controller 54T to allow a modulated operation of the thaw heater 74 under a wide variety of temperatures. In the exemplary embodiment, the thaw heater 74 maintains a temperature of the outer wall of the pipe 22 in the range of 0° C. to 100° C. during the thaw mode of operation. In another embodiment, the thaw heater 74 is an induction type heater. In one embodiment, the device 26 includes a single controller 54T that combine the functions of the freeze controller 54 and the thaw controller 54T. In one embodiment, the thaw controller 54T change modes of operation from a freeze mode to a thaw mode through a manual actuation by the operator.

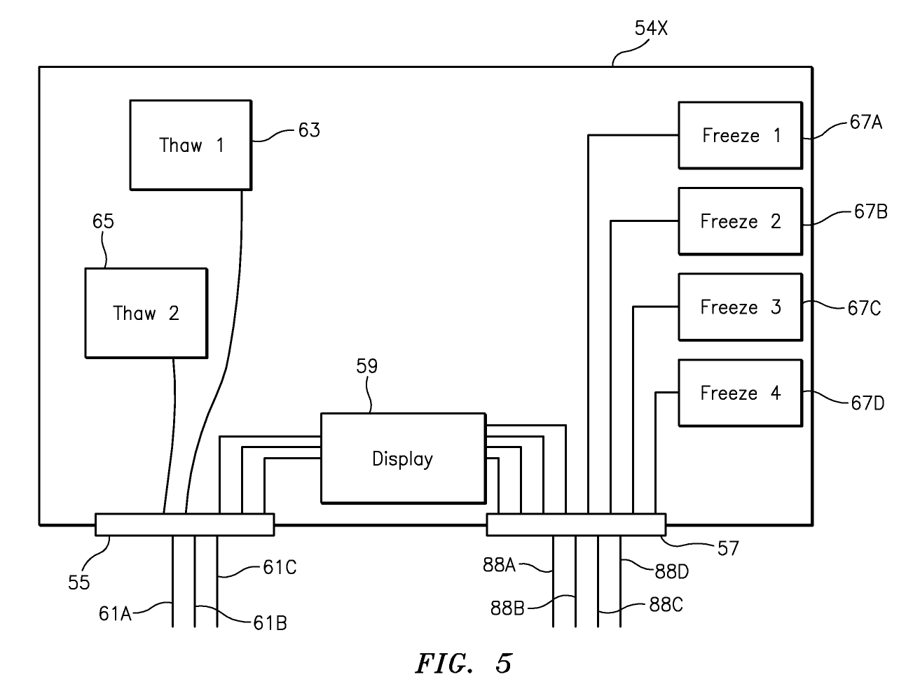

In some embodiments, such as the one illustrated in FIG. 5 for example, there may be a freeze controller 54 associated with each exhaust conduit 72, for a total of four freeze controllers 54. Further, there may be two thaw heaters 54T each with an associated thaw controller 54T for a total of two thaw controllers 54T in device 26.

Disposed about the thaw heater 74 is an insulation layer 80. In the exemplary embodiment, the insulation layer 80 is a flexible closed-cell foam, such as Armaflex™ manufactured by Armacell LLC for example. The insulation layer 80 may be made from any suitable material having an operating range on the order of −185° C. to +177° C. A second, or freeze prevention heater 82 is disposed about the insulation layer 80. The freeze prevention heater 82 is a resistance heater having a heater element (not shown) that generates thermal energy in response to an electrical current. As will be discussed in more detail below, the freeze prevention heater 82 minimizes the buildup of ice due to the freezing of condensed water vapor. In one embodiment, the freeze prevention heater 82 is coupled to the thaw controller 54T. In another embodiment, the freeze prevention heater 82 includes an integrated control circuit that maintains the freeze prevention heater 82 at a constant temperature. In the exemplary embodiment, the freeze prevention heater 82 has a power rating of 0.5 kW to 0.66 kW and a surface area of 9.5 ft² for a 10-inch (0.254 meter) diameter pipe 22.

In one embodiment, a copper mesh 86 is wrapped around the pipe 22 between the jacket 58, 60 and the pipe 22. The copper mesh 86 assists in improving the conductive heat transfer between the jacket 58, 60 and the pipe 22.

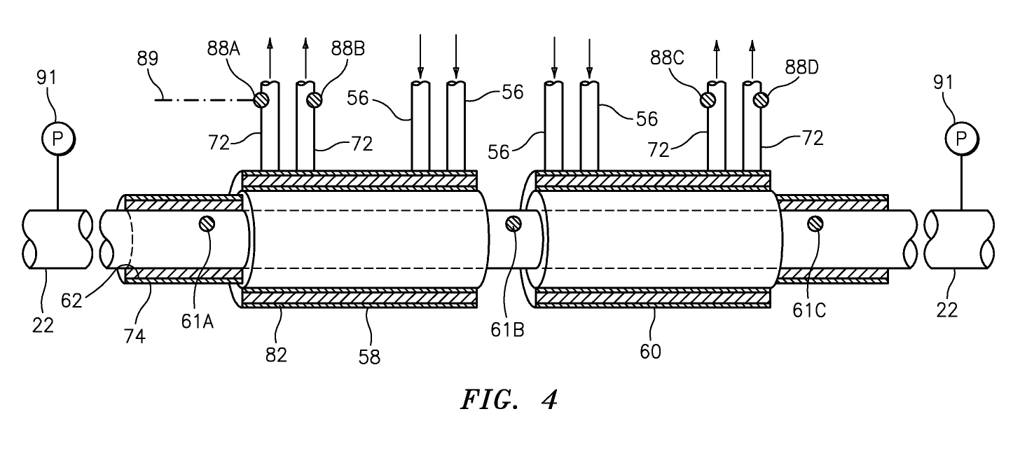

In one embodiment, a set of temperature sensors 61, such as a thermocouple for example, are coupled to the pipe 22 as illustrated in FIG. 4. In the exemplary embodiment, these temperature sensors 61 are disposed on the outer surface of the pipe 22, with the temperature sensors 61A, 61C being located adjacent the ends of the freeze jackets 58, 60 and the temperature sensor 61B being located between the freeze jackets 58, 60. As will be discussed in more detail below, temperature sensors 61 are coupled to a display 59 to provide repair personnel with an indicator on the freeze condition of the pipe 22.

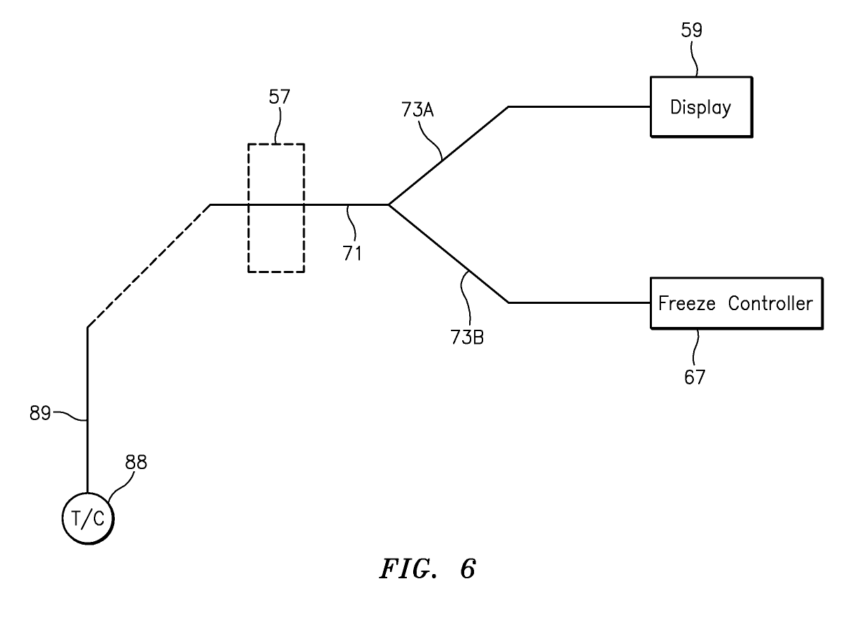

An additional set of temperature sensors 88 is thermally coupled to measure the temperature of the fluid in the exhaust tubes 72. In the exemplary embodiment, the temperature sensors 88A, 88B, 88C, 88D are mounted to the outer surface of each of the exhaust tubes 72. The fluid may be a liquid, however, in the exemplary embodiment, the fluid in the exhaust tubes 72 is a superheated cryogenic gas. In other embodiments, the temperature sensor 88 is mounted within a thermal well (not shown) arranged in the exhaust tubes 72. In yet other embodiments, the exhaust tubes 72 include an opening and the temperature sensor 88 is positioned within the opening to directly measure the fluid temperature. Each of the temperature sensors 88 are electrically coupled to a data transmission media 89 as shown in FIG. 6.

The freeze controller 54 is electrically coupled to the temperature sensors 88, and the solenoid valves 52. The thaw controller 54T is coupled with the thaw heater 74 and temperatures sensors 61 and 78. The device 26 operation is controlled by controllers 54, 54T. Controllers 54, 54T are suitable electronic devices capable of accepting data and instructions, executing the instructions to process the data, and presenting the results. Controllers 54, 54T may accept instructions through user interface, or through other means such as but not limited to electronic data card, voice activation means, manually operable selection and control means (e.g. buttons and switches), radiated wavelength and electronic or electrical transfer. Therefore, controllers 54, 54T can be, but is not limited to, a microprocessor, microcomputer, a minicomputer, an optical computer, a board computer, a complex instruction set computer, an ASIC (application specific integrated circuit), a reduced instruction set computer, a programmable logic controller (PLC), an analog computer, a digital computer, a solid-state computer, a single-board computer, a computer network, a desktop computer, a laptop computer, or a hybrid of any of the foregoing.

Controllers 54, 54T are capable of converting the analog voltage or current level provided by sensors, such as temperature sensor 61 for example, into a digital signal indicative of the temperature of the outer pipe surface pipe 22. Alternatively, the sensors 61, 88 and 78 may be configured to provide a digital signal to controllers 54, 54T, or an analog-to-digital (A/D) converter (not shown) may be coupled between sensors 61, 88 and 78 and controllers 54, 54T to convert the analog signal provided by sensors 61, 88, and 78 into a digital signal for processing by controller 54, 54T. Controllers 54, 54T use the digital signals act as input to various processes for controlling the device 26. The digital signals represent one or more system data including but not limited to pipe surface temperature (Tₚᵢₚₑ), heater element temperature (Tₑₗₑₘₑₙₜ), gas exhaust temperature (Tₑₓₕₐᵤₛₜ), solenoid valve 52 operating state and the like. It should be appreciated that the freeze controller 54 and the thaw controller 54T do not operate simultaneously. In one embodiment, the thaw controller 54T is activated by the operator once the flow of the cryogenic fluid is stopped.

Controllers 54, 54T are operably coupled with one or more components of device 26 by data transmission media 89. Data transmission media 89 includes, but is not limited to, twisted pair wiring, coaxial cable, and fiber optic cable. Data transmission media 89 also includes, but is not limited to, wireless, radio and infrared signal transmission systems. In the embodiment shown in FIGS. 2, 3 and 5, transmission media 89 couples freeze controller 54 to solenoid valve 52 and temperature sensor 88 and the display unit 59. In the embodiment shown in FIGS. 2-5, the transmission media 89 couples the thaw controller 54T to the thaw heater 74, and the temperature sensor 78. Controllers 54, 54T are configured to provide operating signals to these components and to receive data from these components via data transmission media 89.

In general, freeze controller 54 accepts data from sensors 88 and is given certain instructions for the purpose of comparing the data from sensors 88 to predetermined operational parameters. Controller 54T accepts the data from sensors 78 (FIG. 3). Controller 54 provides operating signals to solenoid valve 52. Controller 54 may also accept data from other components, indicating, for example, the pressure of the cooling fluid, or the volume of cooling fluid remaining. The freeze controller 54 compares the operational parameters to predetermined variances (e.g. low flow rate, low pressure, supply level) and if the predetermined variance is exceeded, generates a signal that may be used to indicate an alarm to an operator or a connected computer network (not shown). Additionally, the signal may initiate other control methods that adapt the operation of the device 26, for example the thaw heater 54T may change the operational state of thaw heater 74 to compensate for the out of variance operating parameter. For example, if sensor 78 detects a heater element 76 temperature above a predetermined threshold, the thaw controller 54T may modulate or turn off the thaw heater 74 to maintain a desired operating temperature. As will be described in more detail below, to prevent damage to the thaw heater 74 over a temperature range from −110 C to +100 C. The thaw controller 54T may initiate a change in operation state signal to thaw heater 74 resulting in the thaw heater 74 being cycled on and off during the process of thawing the pipe 22. Another example includes a level of superheat in the exhaust gas that is below a desired level for maximizing the absorption of heat from the pipe 22 while minimizing cooling fluid usage. The controller 54 may initiate a change in state to the valve 52, changing the flow rate of cooling fluid into the chambers 68.

The data received from sensors 61, 78, 88 may be displayed on a user interface coupled to controllers 54, 54T. The user interface may be an LED (light-emitting diode) display, an LCD (liquid-crystal diode) display, a CRT (cathode ray tube) display, or the like. A keypad may also be coupled to the user interface for providing data input to controllers 54, 54T.

In addition to being coupled to one or more components within device 26, freeze controller 54 may also be coupled to external computer networks such as a local area network (LAN) and the Internet. The LAN interconnects one or more remote computers, which are configured to communicate with controller 54 using a well-known computer communications protocol such as TCP/IP (Transmission Control Protocol/Internet(̂) Protocol), RS-232, ModBus, and the like.

Controllers 54, 54T may include a processor coupled to a random access memory (RAM) device, a non-volatile memory (NVM) device, a read-only memory (ROM) device, one or more input/output (I/O) controllers, and a LAN interface device. I/O controllers are coupled to sensors 61, 78, 88, valves 52, and alternatively to a user interface for providing digital data between these devices and bus. I/O controllers may also be coupled to analog-to-digital (A/D) converters, which receive analog data signals from sensors 61, 78, 88.

A NVM device is any form of non-volatile memory such as an EPROM (Erasable Programmable Read Only Memory) chip, a disk drive, or the like. Stored in NVM device are various operational parameters for the application code, such as the methods illustrated in FIGS. 5-8 for example. The various operational parameters can be input to the NVM device either locally, using a keypad or remote computer, or remotely via the Internet using a remote computer. It will be recognized that application code can be stored in a NVM device rather than a ROM device.

Controllers 54 and 54T include operation control methods, such as the methods shown in FIGS. 5-8 for example, embodied in application code. These methods are embodied in computer instructions written to be executed by processor, typically in the form of software. The software can be encoded in any language, including, but not limited to, assembly language, VHDL (Verilog Hardware Description Language), VHSIC HDL (Very High Speed IC Hardware Description Language), Fortran (formula translation), C, C++, Visual C++, Java, ALGOL (algorithmic language), BASIC (beginners all-purpose symbolic instruction code), Perl, ladder logic, visual BASIC, ActiveX, HTML (HyperText Markup Language), and any combination or derivative of at least one of the foregoing. Additionally, an operator can use an existing software application such as a spreadsheet or database and correlate various cells with the variables enumerated in the algorithms. Furthermore, the software can be independent of other software or dependent upon other software, such as in the form of integrated software.

An exemplary Display/Logger 59 is illustrated in FIG. 5. In this embodiment, the device has a display 59 for displaying temperature data from the temperature sensors 61, 78 or 88. The controller 54T also includes a first thaw controller 63, a second thaw controller 65, and four freeze controllers 67A, 67B, 67C, 67D. The first thaw controller 63 and the freeze controllers 67A, 67B are electrically coupled to control the operation of freeze jacket 58. Similarly, the second thaw controller 65 and freeze controllers 67C, 67D are electrically coupled to control the operation of freeze jacket 60.

A pair of data terminals 55, 57 are provided to interface the controllers 63, 65, 67A, 67B, 67C, 67D with the temperature sensors 61, 88. In one embodiment, first data terminal 55 receives data from the temperature sensors 61A, 61B, 61C. In one embodiment, the data terminals 55, 57 are incorporated into and integral with the data logger/display 59. Similarly, the second data terminal 57 receives data from temperature sensors 88A, 88B, 88C and 88D. As discussed above, the temperature data from each of the temperature sensors 61, 88 is provided to the repair personnel through display/logger 59. In one embodiment, the thermocouple wire from the temperature sensors 88 is divided at terminal 57 as shown in FIG. 6. In this embodiment, the conductor 71 from the temperature sensor 88 is split into two conductors 73A, 73B after the terminal 57. One of the conductors 73A couples the temperature sensor 88 to the display 59, while the other conductor 73B provides a connection to a freeze controller, such as freeze controller 67 for example. In the exemplary embodiment, the dividing of the conductor 71 is accomplished by soldering a second wire onto a thermocouple wire.

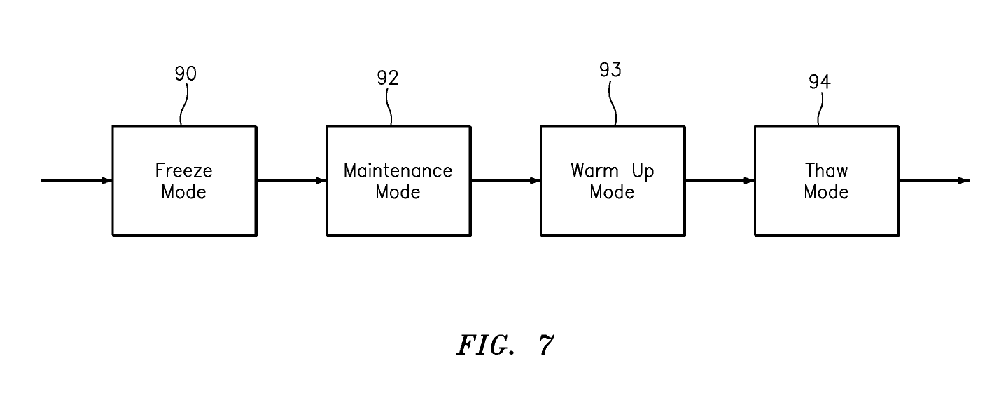

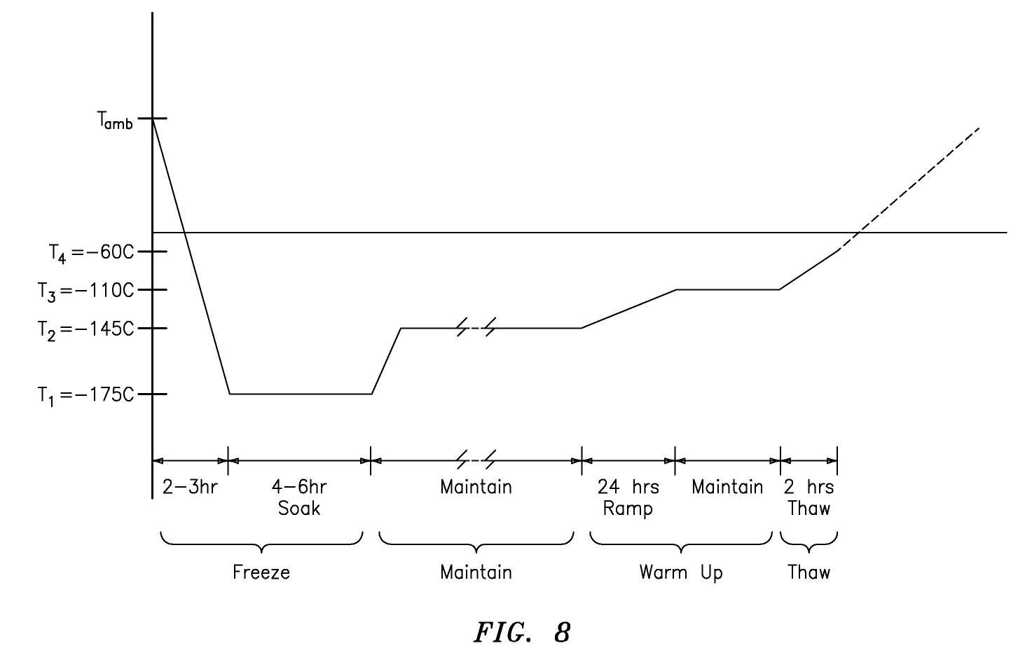

During operation, the device 26 may be considered to operate in four modes, a freeze mode 90, a maintenance mode 92, warm up mode 93, and a thaw mode 94 as shown in FIG. 7. These modes of operation provide for different temperatures during operation as shown in FIG. 8. As will be discussed in more detail below, by varying the temperature profile, the device 26 provides advantages in shortening the time to form and thaw a freeze plug at reduced liquid nitrogen flow.

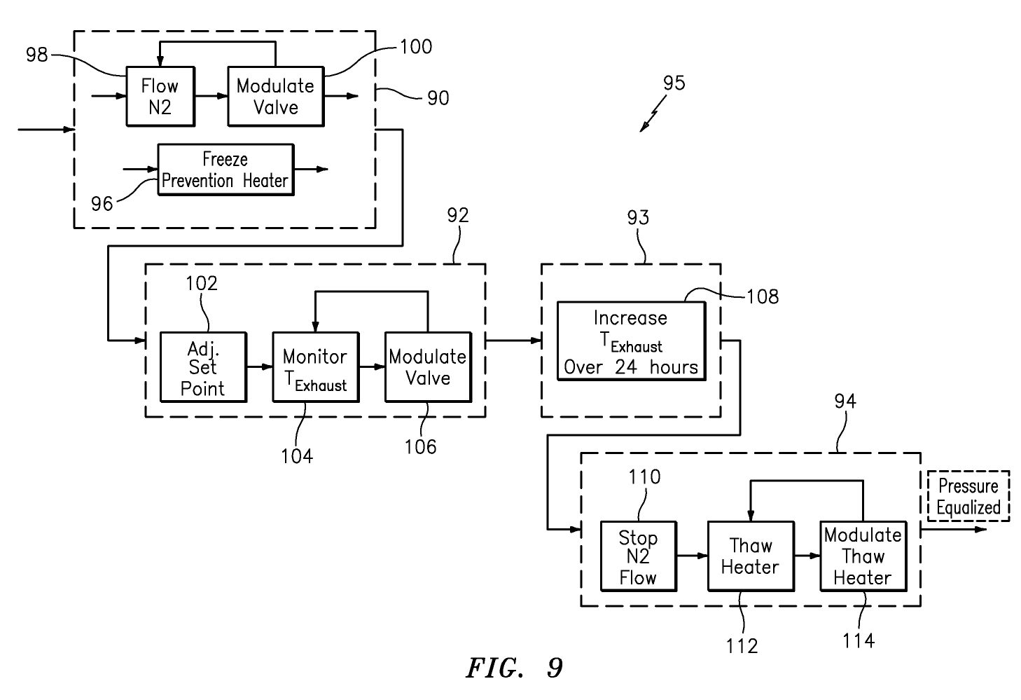

FIG. 9 illustrates an exemplary embodiment of a method 95 of operating the device 26, when the device 26 is operating in modes 90, 92, 93 and 94. The method 95 starts in freeze mode 90. In this mode, the freeze prevention heater 82 is activated in block 96 in parallel with the flow of cooling fluid, such as liquid nitrogen for example, in block 98 into the freeze jackets 58, 60. It should be appreciated that when utilizing cold cooling fluids, such as a cryogenic cooling fluid for example, water will tend to condense on and about the jackets 58, 60. This condensed water also then freezes forming a mass of ice on the large outer surfaces of the jackets. In prior art systems, the mass of ice was very large resulting in extended thaw times as the operators should not chip away at the ice using tools but use thaw requires propane type heaters. It should be appreciated that this was undesirable since it resulted in extended periods (up to 24 hours) before the pipe 22 could be returned to service and there was a potential for damage from the tools. In this embodiment, by operating the freeze prevention heater 82 at a constant temperature, such as 12.8° C. for example, only a minimal amount of ice forms having little or no impact of the thaw time.

The cooling fluid flows within each of the chambers 68, 70 absorbing heat from the fluid 24 through the pipe 22. In the exemplary embodiment, the cooling fluid boils in the chambers 68, 70. This allows the cooling fluid to exhaust through the exhaust tube 72 as a superheated vapor. The solenoid valves 52 are modulated by freeze controller 54 in block 100 to maintain a desired level of superheat by controlling the exhaust temperature Tₑₓₕₐᵤₛₜ measured by the sensor 88. In the embodiment using liquid nitrogen as a cooling fluid, the boiling temperature of the liquid nitrogen is −196.3° C. and the method 95 maintains Tₑₓₕₐᵤₛₜ at −175° C. This allows the freeze jackets 58, 60 to remove heat from the pipe 22 through conduction, radiation, convection and the significant boiling enthalpy of approximately 85 Btu/lb. The method 95 loops between the modulating of valve 52 in block 100 and the flowing of cooling fluid in block 98 until the freeze plug is formed.

This method of using superheated fluid provides advantages over the prior art systems that simply filled the chambers 68, 70 with liquid nitrogen and allowed the liquid nitrogen to flow out the exhaust tube 72. The generation of a superheated gas allowed the generation of a frozen oil plug, within a high voltage transmission pipe 22, in 6-10 hours for an 8-inch conduit and 8-12 hours for a 10-inch pipe. Further, the freeze plug was created and maintained while simultaneously reducing the amount of liquid nitrogen by 30%-45%. This provides the advantage of reducing costs in both material and labor. The variance in the freeze time depends on a number of factors including environmental conditions. An exemplary example of parameters for freeze times in an arbitrary example included in Table 1.

TABLE 1

| | Dielectric | | N2 | | |
|---|---|---|---|---|---|
| | Fluid | Pipe O.D. | exhaust | | Total Freeze |
| Pipe Size | Type | Temp | temp. | Soak Time | Time |
| 10 inch | DCL100 | −160 C. | −175 C. | 4 to 8 | 8 to 12 |
| | | | | hours | hours |

The method 95 remains in freeze mode 90 until a freeze plug is formed from the fluid 24 within the pipe 22 that is sufficiently solid enough and long enough to withstand the pressure of the fluid 24 upstream from the area that maintenance or other tasks need to be performed. In one embodiment, the upstream pressure ranges from 80-150 pounds per square inch (551.6 kPa-1723.8 kPa). In this embodiment, it is desirable to have a freeze plug with a length of 72 inches (1.8 meters) to 91 inches (2.31 meters) to provide a freeze plug with a desired factor of safety. Once a freeze plug of the desired size is formed, the method 95 transfers to maintenance mode 92.

Once the freeze plug is formed and pressure tested by the operators, the flow rate of the cooling fluid may be reduced to maintain the pipe 22 at a desired temperature above the freezing point of the fluid 24. In the exemplary embodiment, the fluid 24 is a dielectric fluid having a freezing point of between −50° C. (DCL-500 type fluid) to −75° C. (DCL-100 type fluid). In this embodiment, the set point for Tₑₓₕₐᵤₛₜ is increased in block 102 such that Tₑₓₕₐᵤₛₜ may be set to vary, between −120° C. to −145° C. To achieve this, the method 95 monitors Tₚᵢₚₑ and Tₑₓₕₐᵤₛₜ in block 104 and modulates the valve 52 in block 106 to maintain the desired temperatures. The method 95 continues to loop between block 104 and block 106 until a predetermined amount of time before the freeze plug is to be thawed. In the embodiment of a high voltage transmission line, the freeze plug may be in place for several weeks while repairs, maintenance or upgrade tasks are performed. A predetermined amount of time prior to the completion of the tasks, the method 95 enters a warm up mode 93 operations. In block 108, the set point for Tₑₓₕₐᵤₛₜ is changed, to gradually increase Tₚᵢₚₑ, to between −85° C. to −115° C. In the exemplary embodiment, the predetermined amount of time is 24 hours. An exemplary example of parameters for maintaining the freeze plug in an arbitrary example included in Table 2.

TABLE 2

| | | Min. N2 | | |
|---|---|---|---|---|
| Pipe | Dielectric | Exhaust | Est. Centerline | N2 Exhaust |
| Size | Fluid Type | Temp. | Temperature | Temperatures |
| 10 inch | DCL100 | −145 C. | −100 C. | Variable < −125 C. |
| | | | to −120 C. | |
| 8 inch | DCL150 | −120 C. | −80 C. | Variable < −100 C. |
| | | | to −95 C. | |

Once the tasks associated with pipe 22 have been completed, the method 95 shifts from warm up mode 93 to thaw mode 94. In thaw mode 94, the method 95 first stops the flow of the cooling fluid in block 110. The thaw heater controller 54T is activated to turn on the thaw heater 74 in block 112. The method 95 monitors the temperature of the heater element 76 in the thaw heater 74 to maintain a temperature below a desired maximum temperature, such as 80° C. for example. The method 95 modulates the thaw heater 74 in block 114 and loops back to block 112 until the freeze plug is thawed. It should be appreciated thaw heater 74 operates over a wide operating environment from −210° C. to 100° C. By maintaining the heater element 76 temperature and modulating the operation of the thaw heater through the thaw heater controller 54T advantages may be gained, in that the reliability and useful life of the thaw heater 74 are extended without significantly impacting the time needed to thaw the freeze plug. In one embodiment, the pressure in the pipe 22 on either side of the device 26 is monitored, such as by pressure transducers 91 (FIG. 4) for example. It should be appreciated that the pressure transducers 91 may be positioned at a distance upstream and downstream from the device 96 Once the pressure on either side of the device 26 has equalized, the freeze plug is considered “thawed” for operational purposes and the method 95 exits the thaw mode 94. An exemplary example of parameters for thawing the freeze plug in an arbitrary example included in Table 3.

TABLE 3

| | Dielectric | N2 Exhaust Temp | Pipe O.D. | | Thaw time if only |
|---|---|---|---|---|---|
| Pipe | Fluid | 24 hours before | Temp at end | Thaw time | natural convention |
| Size | Type | thaw | of Thaw | with heaters | is used |
| 10 | DCL100 | −100 C. | −50 C. | 2.5 hours | 8 to 10 |
| | | | | | hours |
| 8 | DCL150 | −95 C. | −20 C. | 1.5 hours | 5 to 8 |
| | | | | | hours |

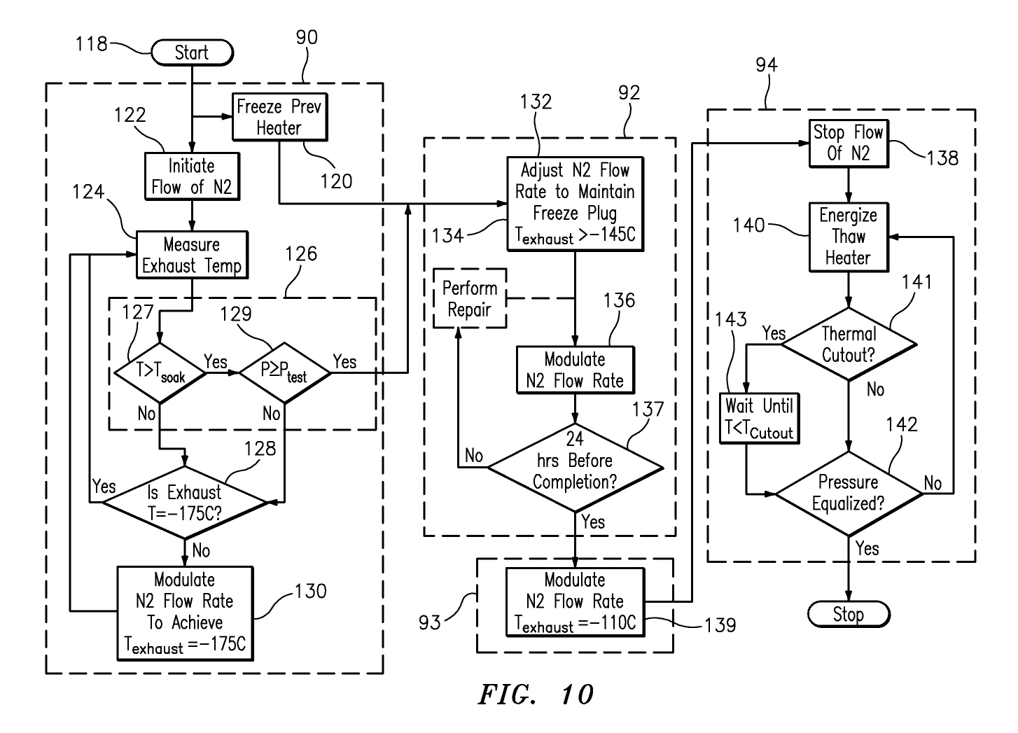

Referring now to FIG. 10, another method 116 of operating the device 26 is illustrated. The method 116 starts in block 118 and initiates freeze mode 90. The freeze prevention heater is turned on in block 120 and its temperature is set for 12.8° C. As discussed above, this prevents or minimizes the build up of water condensate forming ice on the jackets 58, 60. In parallel with the activation of the freeze prevention heater, the method 116 initiates the flow of cooling fluid in block 122. The exhaust temperature Tₑₓₕₐᵤₛₜ is measured in block 124. It should be appreciated that the exhaust temperature Tₑₓₕₐᵤₛₜ may be continuously monitored during freeze mode 90.

The method 116 then proceeds to query block 126 where it is determined if the freeze plug has been formed. This query may be determined in a number of ways, such as by the temperature measured by sensor 61B or the exhaust temperature being at a desired level for a particular period of time, sometimes referred to as a “soak time”. In the exemplary embodiment, the determination of whether the freeze plug has been formed includes the steps of determining whether the predetermined soak time has been reached in block 127. In the exemplary embodiment, the soak time for a 10″ pipe is approximately 6 hours. If block 127 returns a positive, the operator performs a pressure test in block 129 where a predetermined pressure differential is placed across the freeze plug. If the pressure differential is maintained for a predetermined amount of time, the query block 129 returns a positive. If either query block 127 or query block 129 return a negative, the method 116 proceeds to block 128. In another embodiment, the presence of the freeze plug is determined by using at least two temperature sensors 61A, 61C at each end of the freeze jackets 58, 60. In this embodiment, when the temperature at the ends of the freeze jackets 58, 60 reaches a desired level, the freeze plug has been formed.

If the query block 126 (or query blocks 127, 129) returns a negative, the method 116 proceeds to query block 128 where it is determined whether Tₑₓₕₐᵤₛₜ is substantially equal to −175° C. It should be appreciated that the temperature Tₑₓₕₐᵤₛₜ is set depending on the size of the pipe 22. Where the pipe 22 is 10-inches (0.254 meters) in diameter, Tₑₓₕₐᵤₛₜ is set to −175° C., in the case of an 8-inch (0.2032 meters) diameter, Tₑₓₕₐᵤₛₜ is set to −135° C. If query block 128 returns a positive, the method 116 loops back to block 124. If query block 128 returns a negative, the method 116 proceeds to block 130 where the flow of the cooling fluid is adjusted, such as with solenoid valve 52 for example, to achieve the desired Tₑₓₕₐᵤₛₜ. It should be appreciated that the modulation of the flow of cooling fluid in block 130 may be an on-off modulation, or a continuous variation of the flow rate over the operational range of the valve. It should further be appreciated that the controlling of the exhaust temperature may be arranged with hysteresis to avoid continuously cycling the solenoid valve 52.

If the query block 126 returns a positive, the method 116 proceeds to block 132 and the maintenance mode 92 is initiated. Block 132 adjusts the flow of the cooling fluid allowing Tₑₓₕₐᵤₛₜ to vary at a temperature at less than −145° C. The temperature Tₑₓₕₐᵤₛₜ will depend on the diameter of the pipe 22. In one embodiment, the pipe 22 has a 10-inch (0.25 meter) diameter and the desired Tₑₓₕₐᵤₛₜ is −145° C. In another embodiment, the pipe 22 has an 8-inch (0.2 meter) diameter and the desired Tₑₓₕₐᵤₛₜ is −120° C. Block 132 allows the device 26 to keep the freeze plug in place with a sufficient safety factor while also minimizing the amount of cooling fluid consumed. It should be appreciated that the temperature Tₑₓₕₐᵤₛₜ is continuously monitored during maintenance mode 92.

With the freeze plug in place, the operator may then drain the fluid 24 from the segmented section of the pipe 22 downstream from the freeze plug and perform maintenance, repair or upgrade tasks as shown in block 134. In one embodiment, two devices 26 are installed on the pipe 22 on either side of the section where tasks need to be performed. In this embodiment, two freeze plugs are formed creating an isolated segment. In this embodiment, only the fluid 24 in the isolated segment needs to be drained to allow tasks to be performed. This is advantageous in applications, such as high voltage transmission lines, where the pipe 22 may extend for many miles and only a small section needs attention.

A predetermined amount of time before the freeze plug is to be thawed, the method 116 proceeds to block 136 where the cooling fluid flow rate is modulated to maintain the freeze plug in pipe 22. The method 116 then proceeds to query block 137 where it is determined if the repairs are almost complete. In the exemplary embodiment, the query block 137 returns a positive when there is 24 hours prior to the end of repairs. If query block 137 returns a negative, the method 116 loops back to block 134 where repairs continue and the cooling fluid is modulated.

Once query block 137 returns a positive, the method 116 exits maintenance mode 92 and enters warm up mode 93. In block 139, the temperature of the pipe 22 is gradually increased over the predetermined time period by modulating the cooling fluid flow rate such that the temperature Tₑₓₕₐᵤₛₜ is at the desired temperature, such as −110° C. The warm up temperature that Tₑₓₕₐᵤₛₜ is set will depend on the application. In the exemplary embodiment, the warm up temperature of −110° C. is sufficient to allow a refreezing if repair operations take longer than expected.

When the operator is ready to thaw the freeze plug, the method 116 proceeds to thaw mode 94 in block 138. In block 138, the flow of the cooling fluid to the jackets 58, 60 is stopped. The method 116 then proceeds to block 140 where the thaw heater 74 is turned on. The method 116 then proceeds to query block 141 where it is determined if the thermal cutout, such as switch 78 for example has been activated. If query block 141 returns a positive, meaning that the thermal cutout was activated and the thaw heater 74 is operating at or above a desired temperature. The method 116 then proceeds to block 143 where the thaw heater 74 is deactivated until the temperature of the thaw heater 74 is less than the desired maximum temperature. If the query block 141 returns a negative, or once the thaw heater 74 has cooled, the method 116 proceeds to block 142 to determine if the pressure in pipe 22 has equalized on either side of the device 26.

If query block 142 returns a negative, the method 116 loops back to block 140 and continues to thaw the pipe 22 with the thaw heater 74. If the query block 142 returns a positive, then the fluid pressure is the same on either side of the device 26 which indicates that the freeze plug is thawed for operational purposes. It should be appreciated that some fluids, such as dielectric fluid under go a phase change and some portions of the fluid may remain in the solid state or frozen. However, once there is sufficient phase change into a liquid state to allow the pressure to equalize, the method 116 proceeds to block 144 and terminates.

The method 116 provides advantages in reducing the amount of time it takes to thaw the freeze plug. Typically in prior art solutions, the time to thaw a freeze plug was between 8 to 24 hours. Using the method 116, this time to thaw was reduced to 2 hours, which reduces costs in labor and returns the pipe 22 to service in less time.

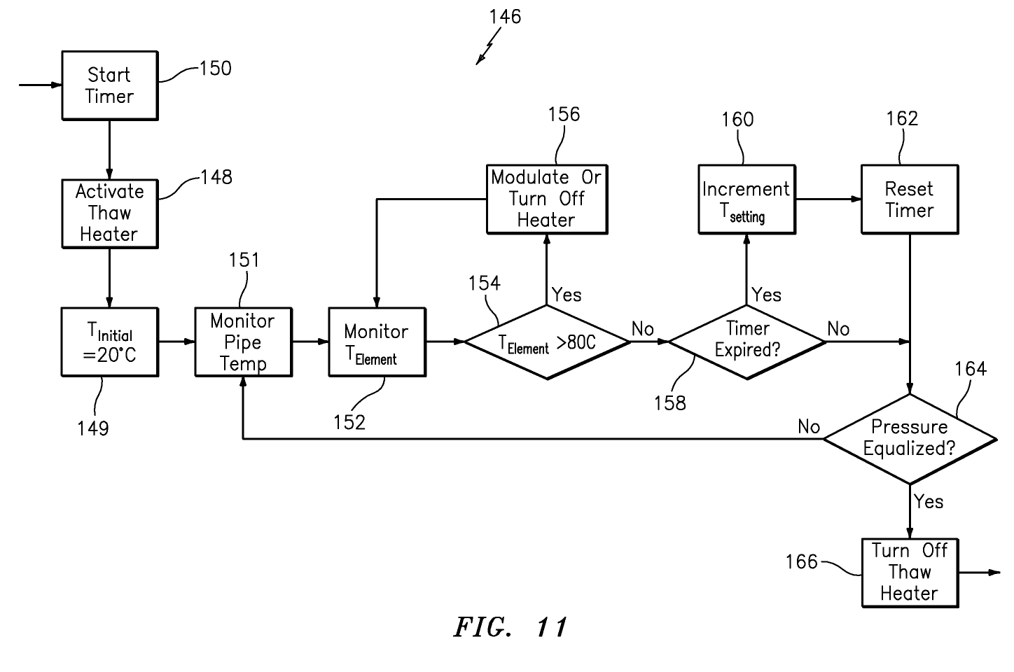

A method 146 of thawing a frozen pipe 22 is illustrated in FIG. 11. It should be appreciated that the method 146 may be used either alone, or as part of thaw mode 94 with methods 95, 116. Method 146 starts by initiating a timer in block 150. The method 146 then proceeds to activate or turning on the thaw heater 74 in block 148. The method then proceeds to block 149 where the thaw heater temperature setting T_{setting} is set to a desired initial set point. In the exemplary embodiment, the initial set point is T_{setting}=20° C. The method 146 then proceeds to block 151 where the pipe 22 temperature Tₚᵢₚₑ is measured and then to block 152 where the temperature Tₑₗₑₘₑₙₜ of the thaw heater element 76 is measured.

The method 146 then proceeds to query block 154 where the thaw heater temperature is compared to a threshold temperature. In the exemplary embodiment, the threshold temperature is 80° C. If query block 154 returns a positive, the method 146 proceeds to block 156 where the thaw heater 74 is either modulated (e.g. electrical current is reduced), or cycled off. By maintaining the temperature Tₑₗₑₘₑₙₜ below the threshold temperature, the reliability and useful life of the thaw heater 74 is increased. Further, it was found that the cycling of the thaw heater 74 to maintain the temperature Tₑₗₑₘₑₙₜ below the threshold temperature did not have a significant impact on the amount of time it took to melt the freeze plug.

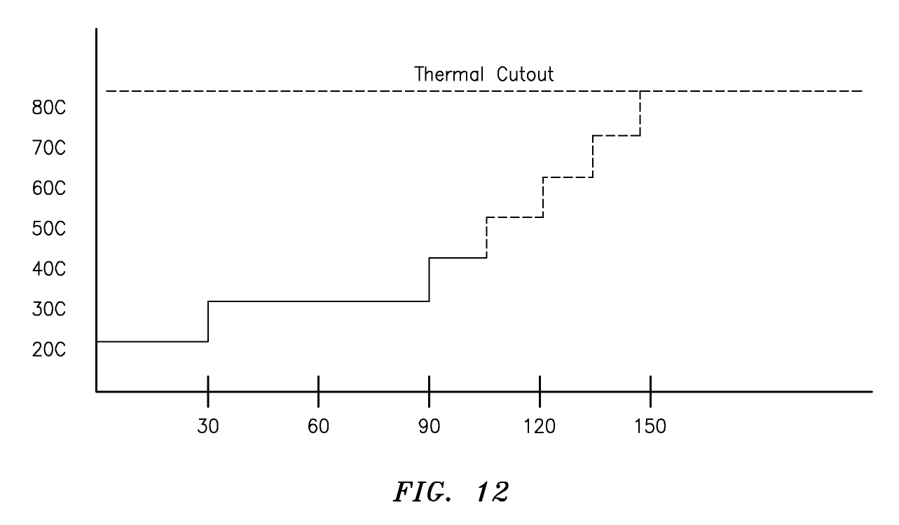

If the query block 154 returns a negative, the method 146 proceeds to query block 158 where it is determined if the timer (set in block 150) has expired. In the exemplary embodiment, the initial timer setting is for 30 minutes. If query block 158 returns a positive, the method 146 proceeds to block 160 where the temperature T_{setting} is incremented. In the exemplary embodiment, the temperature T_{setting} is set to 20° C. for 30 minutes, then incremented by an additional +10° C. for two consecutive a thirty minute time periods. After the initial three time periods, the timer is set to a 15 minute time period and the +10° C. incremental increases continue until the T_{setting} reaches 80° C. or the freeze plug is thawed as illustrated in FIG. 12. The timer is reset in block 162.

If the query block 158 returns a negative, or once the timer has been reset in block 162, the method 146 proceeds to query block 164 where it is determined if the pressure has equalized on either side of the device 26. Query block 164 determines if the freeze plug has been effectively thawed or melted to allow operations to continue. If the query block 164 returns a negative, the method 146 loops back to block 151. If the query block 164 returns a positive, indicating that the freeze plug has been melted a sufficient amount to continue operations, the method 146 proceeds to block 166. In block 166, the method 146 turns off the thaw heater 74.

The device 26 and the methods of operation provide a number of advantages over the prior art. The device 26 and methods of operation generate the freeze plug in a shorter period of time while using 30% to 50% less cooling fluid. The device 26 and methods of operation provide further advantages in the thawing of the freeze plug reducing the time for thawing from 8 to 24 hours to 2 hours. The use of two freeze jackets in the device 26 also allows for redundancy in the event one jacket is damaged or malfunctions during operation.

It should be appreciated that while the embodiments have been described herein with respect to the forming of a freeze plug in high voltage electrical power pipes, the claimed invention should not be so limited. Other applications in which these embodiments may be used include, but are not limited to: boric acid piping use in nuclear power, oil pipelines, hydraulic lines, fruit juices pipes and in the fuel lines and deicing of airplane wings for example.

An embodiment of the invention may be embodied in the form of computer-implemented processes and apparatuses for practicing those processes. The present invention may also be embodied in the form of a computer program product having computer program code containing instructions embodied in tangible media, such as floppy diskettes, CD-ROMs, hard drives, USB (universal serial bus) drives, or any other computer readable storage medium, such as random access memory (RAM), read only memory (ROM), or erasable programmable read only memory (EPROM), for example, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to manage the formation and thawing of a freeze plug in a conduit.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A device for warming a frozen pipe, said device comprising:
a first heater disposed about said frozen pipe, said first heater having a heating element;
an insulation layer disposed about said first heater;
a second heater disposed about said first heater;
a temperature sensor in thermal contact with said heating element.

2. The device of claim 1 further comprising a controller electrically coupled to said temperature sensor and said first heater, wherein said controller includes a processor responsive to executable computer instructions to activate said first heater when said temperature sensor measures a first temperature and to deactivate said first heater when said temperature sensor measures a second temperature.

3. The device of claim 2 wherein said first heater is operable over a temperature range of −210 C to 100 C.

4. The device of claim 3 wherein said processor is further responsive to executable instructions to increment a temperature setting on said first heater after a predetermined time period.

5. A device for generating a freeze plug, said device comprising:
a first jacket;
a first tube fluidly coupled to said first jacket adjacent a first end;
a second tube fluidly coupled to said first jacket adjacent a second end, wherein said second end is opposite said first end;
a first valve coupled to said first tube;
a first temperature sensor thermally coupled to said second tube; and,
A controller electrically coupled to said first temperature sensor and said first valve, said controller having a processor responsive to executable computer instructions for modulating said first valve in response to a signal from said first temperature sensor for maintaining a superheated level of a gas flowing from said first jacket through said second tube.

6. The device of claim 5 wherein said first jacket includes a first half rotatably coupled to a second half.

7. The device of claim 6 further comprising:
a first heater disposed about said first jacket;
an insulation layer disposed about said first heater; and,
a second heater disposed above said insulation layer.

8. The device of claim 7 further comprising:
a third tube fluidly coupled to said first jacket second half adjacent said first end;
a fourth tube fluidly coupled to said first jacket second half adjacent said second end;
a second valve coupled to said third tube and electrically coupled to said controller;
wherein said first tube and said second tube are fluidly coupled to said first half.

9. The device of claim 8 further comprising a liquid nitrogen source fluidly coupled to said first tube and said third tube.

10. The device of claim 9 wherein said first tube and said third tube are vacuum insulated hoses.

11. The device of Claim 10 further comprising:
a second jacket disposed about a pipe adjacent to said first jacket, said second jacket having a first half rotatably coupled to a second half;
a fifth tube fluidly coupled to said second jacket first half adjacent a third end;
a sixth tube fluidly coupled to said second jacket second half adjacent a fourth end;
a third valve coupled to said fifth tube;
a fourth valve coupled to said sixth tube;
a seventh tube fluidly coupled to said second jacket first half adjacent said third end opposite said fifth tube; and,
an eighth tube fluidly coupled to said second jacket second half adjacent said fourth end opposite said sixth tube.

12. The device of Claim 11 further comprising:
a second temperature sensor thermally coupled to said fourth tube, said second temperature sensor being electrically coupled to said controller, wherein said processor is further responsive to executable computer instructions for modulating said second valve in response to a first signal from said second temperature sensor for maintaining a superheat level of said gas flowing from said first jacket through said fourth tube;
a third temperature sensor thermally coupled to said seventh tube, said third temperature sensor being electrically coupled to said controller, wherein said processor is further responsive to executable computer instructions for modulating said third valve in response to a second signal from said third temperature sensor for maintaining said superheat level of said gas flowing from said second jacket through said seventh tube;
a fourth temperature sensor thermally coupled to said eighth tube said fourth temperature sensor being electrically coupled to said controller, wherein said processor is further responsive to executable computer instructions for modulating said fourth valve in response to a third signal from said fourth temperature sensor for maintaining said superheat level of said gas flowing from said second jacket through said eighth tube.

13. A method of operating a device for warming a frozen pipe, said method comprising:
operating a first heater, wherein said first heater is disposed about said frozen pipe, said first heater having a heater element;
monitoring a first temperature of said heater element;
disabling said first heater when said first temperature exceeds a first threshold; and,
operating a second heater at a substantially constant second temperature, wherein said second heater is disposed about said first heater.

14. The method of Claim 13 further comprising:
adjusting a flow rate of a cryogenic fluid a predetermined amount of time prior to operating said first heater.

15. The method of Claim 14 further comprising the step of stopping said flow of said cryogenic fluid when said first heater is operated.

16. The method of Claim 15 wherein:
said first threshold is 80° C.;
said second temperature is 12.8° C.; and
said predetermined amount of time is 24 hours.

17. A method of operating a device for forming a freeze plug in a pipe, said method comprising:
flowing a cryogenic liquid into a first chamber, wherein said first chamber is in thermal contact with said pipe;
boiling said cryogenic liquid in said first chamber to form a superheated cryogenic gas;
monitoring a first temperature of said cryogenic gas exiting said first chamber;
modulating a first valve to adjust said flow of said cryogenic liquid in response to said first temperature;
maintaining said first temperature of said cryogenic gas at a desired level of superheat by modulating said first valve;
operating a first heater at a substantially constant second temperature; and,
forming a freeze plug in said pipe.

18. The method of Claim 17 further comprising:
decreasing a flow rate of said cryogenic liquid into said first chamber a predetermined amount of time before thawing said freeze plug; and,
modulating said first valve to maintain said cryogenic gas exiting said first chamber at a third temperature in response to said decreasing of said cryogenic liquid flow rate.

19. The method of Claim 18 further comprising:
stopping said flow of said cryogenic liquid after said predetermined amount of time;
operating a second heater, wherein said second heater is positioned between said first heater and said pipe, wherein said second heater includes at least one heating element;
monitoring a fourth temperature of said at least one heating element; and,
modulating said operation of said second heater to maintain said fourth temperature below a first threshold.

20. The method of Claim 19 further comprising:
placing said first chamber in thermal contact with said pipe;
disposing said second heater about said first chamber and said pipe;
disposing a layer of insulation about said second heater; and,
disposing said first heater about said layer of insulation.

21. The method of Claim 18 further comprising:
modulating said first valve to decrease said flow of said cryogenic liquid after said freeze plug has been formed; and,
maintaining a fifth temperature of said cryogenic gas by modulating said first valve.

22. The method of Claim 21 wherein said cryogenic gas is at a first level of superheat when said cryogenic gas is said first temperature and at a second level of superheat when said cryogenic gas is said third temperature, and a third level of superheat when said cryogenic gas is said fifth temperature.

23. The method of Claim 17 further comprising:
maintaining said cryogenic gas at a first level of superheat for a predetermined soak time; and,
forming a pressure differential across said freeze plug after said predetermined soak time.

24. The method of Claim 23 wherein said cryogenic gas is maintained at a fifth temperature after forming said pressure differential.
